(19) United States
(12) Patent Application Publication
(10) Pub. No.: US 2009/0193921 A1
(43) Pub. Date: Aug. 6, 2009

(54) SPEED CHANGE OPERATION APPARATUS FOR A VEHICLE

(75) Inventors: Harumichi Ishizu, Shizuoka (JP); Yasushi Tajima, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Atsumitec, Shizuoka-ken (JP)

(21) Appl. No.: 12/171,050

(22) Filed: Jul. 10, 2008

(30) Foreign Application Priority Data
Jul. 10, 2007 (JP) 2007-180670

(51) Int. Cl. F16H 59/04; B29C 39/02

(52) U.S. Cl. 74/473.3; 264/299

(57) ABSTRACT

A speed change operation apparatus for a vehicle can comprise an operating lever for performing speed change operation of a transmission of a vehicle by a pivotal operation of the operating lever. An operating knob can be secured on the tip end of the operating lever and adapted to be gripped by a driver of vehicle. A push knob can be mounted on the operation knob and adapted to be actuated by a driver to descent a lock-pin rod arranged within the operating lever. The push knob can be outsert-molded by soft resin at its first portion abutting the lock-pin rod when the push knob is actuated or at its second portion abutting the operating knob after the actuation of the push knob.

### CROSS-REFERENCE TO RELATED APPLICATIONS

The present application is based on and claims priority under 35 U.S.C. § 119 to Japanese Patent Application No. 2007-180670, filed on Jul. 10, 2007, the entire contents of which is expressly incorporated by reference herein.

### BACKGROUND OF THE INVENTIONS

1. Field of the Inventions

The present inventions relate to a speed changing operation apparatus for vehicle for carrying out the speed changing operation of a transmission.

2. Description of the Related Art

Speed change operation apparatus for vehicles (also known as “gear shifters”) in general usually include an operating lever pivotally supported on a body of the speed change operation apparatus and a knob mounted on the tip end of the operating lever. A driver can change speeds of a transmission of a vehicle by pivotally operating the operating lever while gripping the operating knob.

Various designs for speed change operation apparatuses include a lock that prevents pivotal motion of the operating lever, can be released by pushing down a lock-pin rod arranged within the operation lever by operating a push knob mounted on the operating knob. Japanese Laid-open Patent Publication No. 166830/1996 discloses a speed change operation apparatus which can suppress operation noise generated during operation of the push knob. According to the speed change operating apparatus of this prior art, the suppression of generation of the operation noise is achieved by forming the entire push knob of elastomer.

### SUMMARY OF THE INVENTIONS

An aspect of at least one of the embodiments disclosed herein includes the realization that a problem is presented when such a push knob is formed entirely of elastomer. That is, when the entire push knob is formed of relatively soft resin, it is difficult to keep the strength or rigidity of the push knob. On the other hand, when the entire push knob is formed of relatively hard resin, it is difficult to effectively suppress the operation noise.

It is, therefore, an object of at least some of the present inventions to provide a speed change operation apparatus for a vehicle which can both suppress the operation noise of the push knob and keep a necessary strength and rigidity of the push knob.

Thus, in accordance with an embodiment, a speed change operation apparatus for a vehicle can comprise an operating lever configured to perform speed change operation of a transmission of a vehicle by a pivotal operation of the operating lever. An operating knob can be secured on an end of the operating lever and adapted to be gripped by a driver of vehicle. A push knob can be mounted on the operation knob and can be adapted to be actuated by a driver to descent a lock-pin rod arranged within the operating lever. Additionally, the push knob can be outsert-molded by soft resin at a first portion abutting the lock-pin rod when the push knob is actuated or at its second portion abutting the operating knob after the actuation of the push knob.

In accordance with another embodiment, a speed change operation apparatus for a vehicle can comprise an operating lever operatively connected to a transmission of a vehicle and having a first end. An operating knob can be secured on a the first end of the operating lever and adapted to be gripped by a driver of vehicle. A push knob can be mounted on the operation knob and can be adapted to be actuated by a driver to drive a lock-pin rod arranged within the operating lever. The push knob can have a first portion configured to abut the lock-pin rod and a second portion configured to abut a portion of the operating knob. At least one of the first and second portions of the push knob is outsert-molded by soft resin

### BRIEF DESCRIPTION OF THE DRAWINGS

Additional advantages and features of the present inventions will become apparent from the subsequent description and the appended claims, taken in conjunction with the accompanying drawings, wherein:

FIG. 1 is a longitudinal section view of the speed change operation apparatus for a vehicle in accordance with an embodiment;

FIG. 2 is a perspective view of the push knob used in the speed change operation apparatus for a vehicle of FIG. 1;

FIG. 3 is a plane view and a side elevation view of the push knob;

FIG. 4 is a cross-sectional view taken along a line IV-IV of FIG. 3;

FIG. 5 is a cross-sectional view taken along a line V-V of FIG. 3;

FIG. 6 a schematic view showing molds used in the outsert-molding of the push knob; and

FIG. 7 is a plane view showing molds used in the outsert-molding of the push knob.

### DETAILED DESCRIPTION OF THE PREFERRED EMBODIMENT

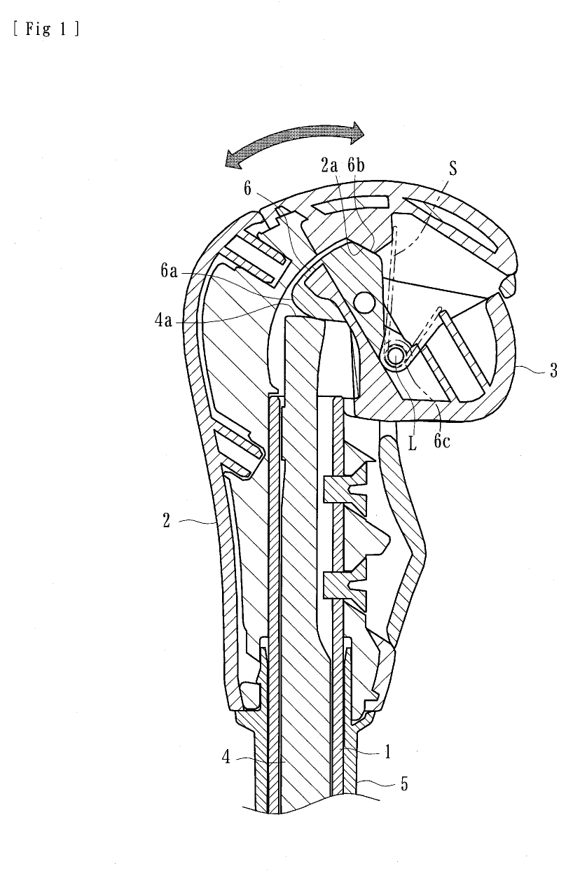

The speed change operation apparatus for a vehicle of one embodiment of the present invention is used for performing speed change operation of a transmission of a vehicle. The speed change operation apparatus can comprise, as shown in FIG. 1, an operating lever 1 pivotally operated by a driver, an operating knob 2 mounted on the tip end of the operating lever 1, and a push knob 3 mounted on the operating knob 2. The speed change operation apparatuses disclosed herein are described in the context of a speed changing apparatuses for a vehicle. However, the speed change operation apparatuses disclosed herein can have utility in other contexts, wherever a knob is used on the end of a lever.

The operating lever 1 is pivotally mounted on a body (not shown) of the speed change operation apparatus adapted to be mounted on a body of a vehicle to perform the speed change operation of a transmission (not shown) of a vehicle by pivotally moving the operating lever 1 along a direction shown by an arrow in FIG. 1. The operating lever 1 can comprise a cylindrical member into which a lock-pin rod 4 described later more in detail is inserted.

The operating knob 2 can be gripped by a driver and can be mounted on a tip end (top end) of the operating lever 1. The push knob 3 can be pivotally mounted on the operating knob 2 at the front side thereof. In some embodiments, the push knob 3 pivots around a pivotal shaft “L” to descend the lock-pin rod 4.

The lock-pin rod 4 is structured so that it is engaged with a body (not shown) of the speed change operation apparatus when the operating lever 1 is positioned at a predetermined position to prevent the pivotal motion of the operating lever 1. However the pivotal motion of the operating lever 1 is permitted when the lock-pin rod 4 is descended by pivotally moving the push knob 3. A cover 5 can have a configuration continuously extending from the bottom end of the operating knob 2 to cover a circumferential surface of the operating lever 1.

In some embodiments, the push knob 3 can have a surface 3a which projects from the operating knob 2 when mounted thereon. The back side, opposite to the surface 3a, can be outsert-molded by soft resin 6 (i.e. the back side of the push knob 3 is insert-molded in the soft resin 6).

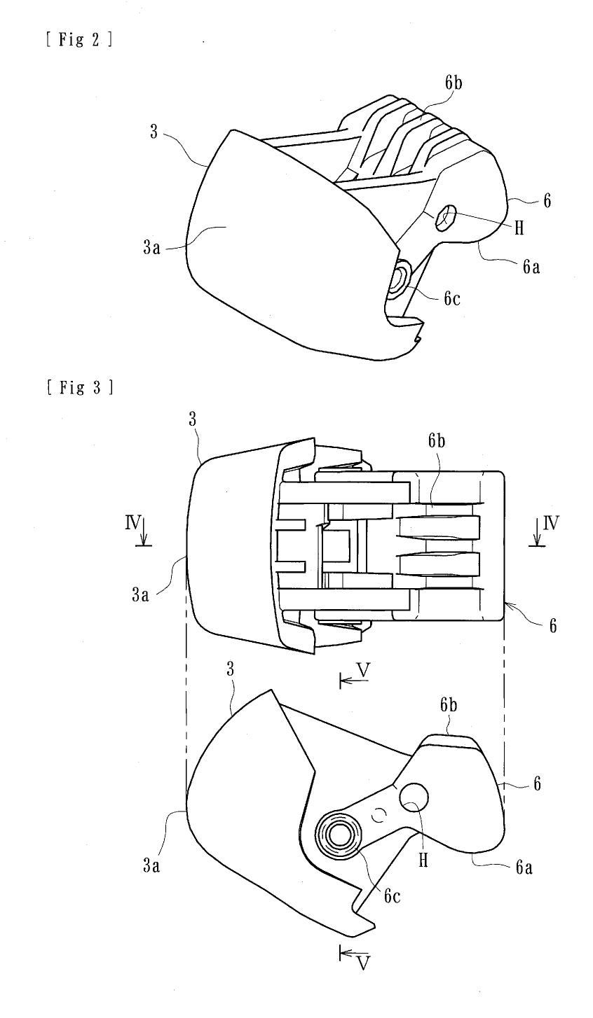

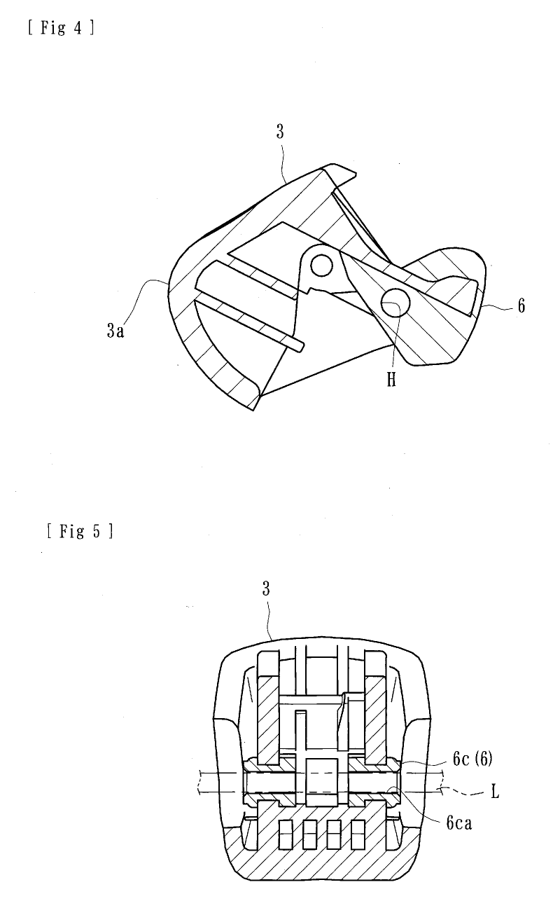

The soft resin 6 can comprise a resin (e.g. elastomer) having cushion nature and characteristics softer than the material (e.g. hard resin such as ABS etc.) of the push knob 3. The push knob 3 can have, as shown in FIGS. 2˜4, a first portion 6a, a second portion 6b and a third portion 6c.

The first portion 6a can abut the top end 4a of the lock-pin rod 4 when the push knob 3 is operated, and the second portion 6b is that which abuts a predetermined portion 2a of the operating knob 2 after the operation of the push knob 3. The lock-pin rod 4 is usually urged or biased upward and the push knob 3 is also urged by a spring “S” toward its initial position (position before the pivotal operation of the push knob 3). Accordingly the push knob 3 can be returned to its initial position by said urging forces after its operation and can abut the predetermined portion 2a within the operating knob 2.

In embodiments where the push knob 3 is covered (i.e. outsert-molded) by the soft resin 6 rich of cushion nature at its first portion 6a which abuts the lock-pin rod 4, when the push knob 3 is operated and at its second portion 6b which abuts the operation knob 2 after the operation of the push knob 3, the operation noise of the push knob 3 generated during its operation can be suppressed. It is of course that necessary strength and rigidity of the push knob 3 can be kept since the push knob 3 itself is made of hard resin such as ABS etc.

In addition, in some embodiments, the second portion 6b can be formed as having a ribbed configuration. This enables to improve the cushion nature and thus to further suppress the operation noise of the push knob 3. In the illustrated embodiment, although it is shown that the second portion 6b has the ribbed configuration, it may be possible to provide the first portion 6a with the ribbed configuration or to provide both the first and second portions 6a, 6b with ribbed configuration.

The third portion 6c is formed integrally with the first and second portions 6a, 6b and is formed as shown in FIG. 5 with a pivotal shaft aperture 6ca through which a pivotal shaft “L” of the push knob 3 is inserted is formed. The portion through which the pivotal shaft “L” is inserted is partially filled with the soft resin 6. This enables to prevent generation of rattle between the pivotal shaft “L” and the pivotal shaft aperture 6ca and thus to further suppress generation of the operation noise.

As can be seen from the description above since the push knob 3 is outsert-molded by the soft resin 6 at portions engaging or abutting other portions of the speed change operation apparatus, it can effectively absorb shocks and thus suppress the operation noise of the push knob 3. On the other hand since the push knob 3 itself is made of hard resin such as ABS etc., the strength and rigidity of the push knob 3 are also kept.

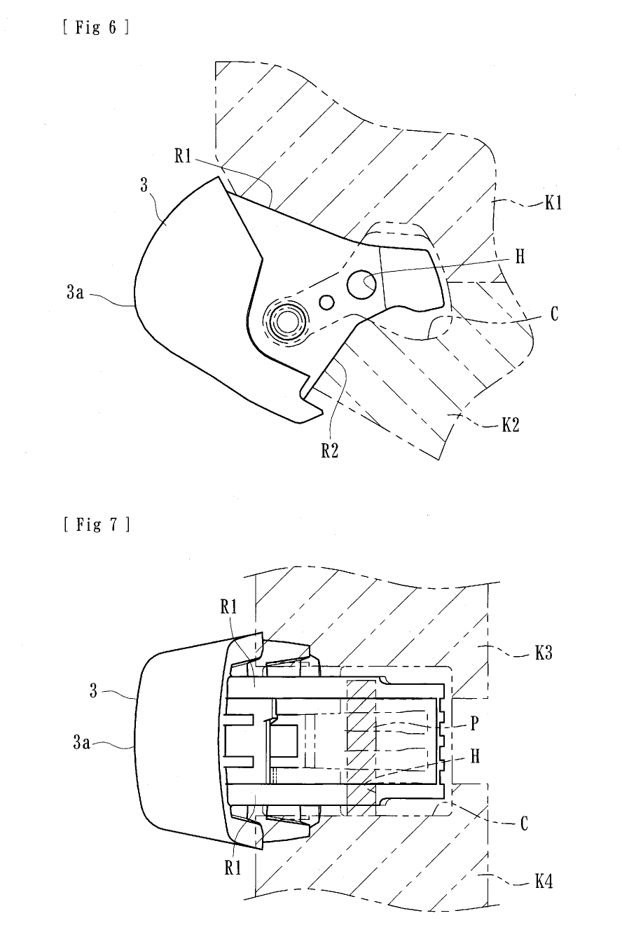

In addition the push knob 3 can be formed with portions of the push knob 3 to be held by molds during the outsert-molding of the soft resin 6 on the push knob 3 so that the surface 3a of the push knob 3 is placed at the outside of the molds and the first, second and third portions 6a, 6b, 6c are placed within a cavity “C” of the molds during the outsert-molding of the push knob 3. For example, said portions of the push knob 3 to be held by molds during the outsert-molding are outline portions R1, R2 and a bore “H” of the push knob 3 as shown in FIGS. 6 and 7. During the outsert-molding process the outline portions R1, R2 are sandwiched and held by molds K1, K2 and a holding pin “P” extending from a mold K4 is inserted into the bore “H” to hold the push knob 3.

The molds K1˜K4 are molds for outsert-molding the soft resin 6 on the push knob 3 and form the cavity “C” when they are closed each other. The outsert-molding can be performed by charging the cavity “C” with molten soft resin 6 and then by cooling and solidifying the resin. During which since the surface 3a of the push knob 3 is held by the molds K1, K2 and the pin “P” via the outline portions R1, R2 and the bore “H” so that the surface 3a of the push knob 3 is kept outside the molds K1˜K4, it is possible to prevent the surface 3a from being damaged by the molds.

It should be understood that the technical effect of preventing the surface 3a from being damaged is valuable since the surface 3a of the push knob 3 has various decorated treatments coming in sight. Other portions of the push knob 3 may be used for holding the push knob 3 in place of the portions R1, R2, H.

Since the first and second portions 6a, 6b respectively abutting the lock-pin rod 4 and the operating knob 2 during operation of the push knob 3 are outsert-molded by the soft resin 6, it is possible to suppress the operation noise of the push knob 3 and keep the necessary strength and rigidity thereof. In addition since the first, second and third portions 6a, 6b and 6c can be integrally outsert-molded, it is possible to reduce manufacturing steps as compared with a method of forming these portions separately.

Although the present invention has been described with reference to the preferred embodiment, it should be appreciated that the present invention is not limited to the illustrated and described embodiment. For example, the present invention may be applied to any push knob in which only the first and second portions 6a, 6b are formed (i.e. that the third portion 6c is not formed) or either one of the first, second or third portion 6a, 6b or 6c is formed. In addition although the push knob 3 pivotal around the pivotal shaft “L” is illustrated, the present invention can be applied to other type of push knob such as a sliding type push knob.

The speed change operation apparatuses for a vehicle disclosed herein can be applied to any push knob having a different outline configuration or additional functions if it is characterized in that the push knob is outsert-molded by soft resin at its first portion abutting the lock-pin rod when the push knob is actuated or at its second portion abutting the operating knob after the actuation of the push knob.

What is claimed is:

1. A speed change operation apparatus for a vehicle comprising:
an operating lever configured to perform speed change operation of a transmission of a vehicle by a pivotal operation of the operating lever;
an operating knob secured on an end of the operating lever and adapted to be gripped by a driver of vehicle; and
a push knob mounted on the operation knob and adapted to be actuated by a driver to descent a lock-pin rod arranged within the operating lever;
wherein the push knob is outsert-molded by soft resin at a first portion abutting the lock-pin rod when the push knob is actuated or at its second portion abutting the operating knob after the actuation of the push knob.

2. A speed change operation apparatus for a vehicle of claim 1 wherein the soft resin outsert-molded at the first portion or the second portion has a ribbed configuration.

3. A speed change operation apparatus for a vehicle of claim 1 wherein the push knob is pivotally mounted within the operating knob and outsert-molded of the soft resin at its third portion in which a pivotal shaft aperture through which a pivotal shaft of the push knob is inserted is formed.

4. A speed change operation apparatus for a vehicle of claim 2 wherein the push knob is pivotally mounted within the operating knob and outsert-molded of the soft resin at its third portion in which a pivotal shaft aperture through which a pivotal shaft of the push knob is inserted is formed.

5. A speed change operation apparatus for a vehicle of any one of claim 1 wherein the push knob is formed with portions to be held by molds and a holding pin, and wherein the external surface of the push knob is placed at the outside of the molds and the first and second portions are placed within a cavity during the outsert-molding the push knob with the soft resin by the molds.

6. A speed change operation apparatus for a vehicle of any one of claim 2 wherein the push knob is formed with portions to be held by molds and a holding pin, and wherein the external surface of the push knob is placed at the outside of the molds and the first and second portions are placed within a cavity during the outsert-molding the push knob with the soft resin by the molds.

7. A speed change operation apparatus for a vehicle of any one of claim 3 wherein the push knob is formed with portions to be held by molds and a holding pin, and wherein the external surface of the push knob is placed at the outside of the molds and the first and second portions are placed within a cavity during the outsert-molding the push knob with the soft resin by the molds.

8. A speed change operation apparatus for a vehicle of any one of claim 4 wherein the push knob is formed with portions to be held by molds and a holding pin, and wherein the external surface of the push knob is placed at the outside of the molds and the first and second portions are placed within a cavity during the outsert-molding the push knob with the soft resin by the molds.

9. A speed change operation apparatus for a vehicle comprising:
an operating lever operatively connected to a transmission of a vehicle and having a first end;
an operating knob secured on a the first end of the operating lever and adapted to be gripped by a driver of vehicle; and
a push knob mounted on the operation knob and adapted to be actuated by a driver to drive a lock-pin rod arranged within the operating lever, the push know having a first portion configured to abut the lock-pin rod and a second portion configured to abut a portion of the operating knob;
wherein at least one of the first and second portions of the push knob is outsert-molded by soft resin.

10. A speed change operation apparatus for a vehicle of claim 9 wherein at least one of the first portion and second portions has a ribbed configuration made of the soft resin.

11. A speed change operation apparatus for a vehicle of claim 1 wherein the push knob comprises a third portion including a pivotal shaft aperture outsert-molded of the soft resin and a pivotal shaft is disposed in the pivotal shaft aperture.

12. A speed change operation apparatus for a vehicle of claim 1 wherein the push knob is formed with portions to be held by molds and a holding pin, and wherein the external surface of the push knob is placed at the outside of the molds and the first and second portions are placed within a cavity during the outsert-molding the push knob with the soft resin by the molds.

13. A method of manufacturing a speed change operation apparatus for a vehicle of claim 1 wherein the push knob is formed with portions to be held by molds and a holding pin, and wherein the external surface of the push knob is placed at the outside of the molds and the first and second portions are placed within a cavity during the outsert-molding the push knob with the soft resin by the molds.
